(19) United States
(12) Patent Application Publication
(10) Pub. No.: US 2005/0017937 A1
(43) Pub. Date: Jan. 27, 2005

(54) Active matrix driver

(76) Inventors: Chueh-Ju Chen, Miao-Li (TW); Tsau Hua Hsieh, Miao-Li (TW); Chiu-Lien Yang, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/899,592

(22) Filed: Jul. 26, 2004

(30) Foreign Application Priority Data
Jul. 25, 2003 (TW) 92120353

(51) Int. Cl. G02F 1/136

(52) U.S. Cl. 345/87

(57) ABSTRACT

An active matrix driver (10) adapted to controlling display image of a liquid crystal display includes a number of pixel electrode (13), a common electrode (15) combined with the pixel electrode forming a number of capacitances, a number of scanning lines (21) and signal lines (22) intersecting with each other respectively, and a number of thin film transistors (24) positioned vicinity corners of the scanning lines and signal lines, and electrically connected with the pixel electrode, the scanning lines and the signal lines. A time period of the voltage applied on the pixel electrode is changeable according to the gray level needed by the image, and so display different grays are obtained through controlling the time that the voltages is applied to the LCD device.

### BACKGROUND OF THE INVENTION

1. Field of the Invention

The present invention relates to active matrix drivers, and especially to an active matrix driver typically used in a liquid crystal display (LCD) device.

2. Description of the Prior Art

In general, in comparison with CRT (cathode ray tube) display devices, LCD devices have various advantages including being thin and having low power consumption. Therefore LCD devices are expected to gradually replace CRT display devices in at least some fields of industry and commerce.

FIGS. 5 and 6 shows a conventional active matrix driver 100 used in an LCD device (not shown). The active matrix driver 100 comprises a number of parallel scanning lines 101 (numbered from 0 to n-1) and a number of parallel signal lines 102 (numbered from 0 to m-1) perpendicularly intersecting each other, pixel electrodes 103, common electrodes 105 respectively opposite to the pixel electrodes 103, and TFTs (Thin Film Transistors) 104 as the switching elements. The TFTs 104 are located in the vicinity of the intersections of the scanning lines 101 and the signal lines 102, for driving the pixel electrodes 103. The scanning lines 101 are connected to gate electrodes 1040 of the TFTs 104, the signal lines 102 are connected to source electrodes 1041 of the TFTs 104, and drain electrodes 1042 of the TFTs 104 are connected to the pixel electrodes 103. Each pixel electrode 103 combined with a corresponding common electrode 105 forms a capacitance 107.

FIGS. 7(a) and 7(b) diagrammatically show waveforms of the gate electrodes 1040 and the source electrodes 1041 of the TFTs 104. FIG. 7(c) shows waveforms of the pixel electrodes 103. In operation, regarding just one of the TFTs 104, at the time t1, the source electrode 1041 is supplied a signal voltage V_{d}, and the gate electrode 1040 is supplied a scanning pulse Vg in sequence. The TFT 104 is open and the signal voltage V_{d} is applied to the pixel electrode 103 via the source electrode 1041 and the drain electrode 1042 of the TFT 104. At the time t2, the TFT 104 is closed, but the signal voltage V_{d} is kept by the capacitance 107 until the time t3, when the TFT 104 is reopened. As shown in the FIG. 7(c), the pixel voltage follows the signal voltage V_{d}. In the time from t1 to t2, the pixel voltage increases to Vₚ, and in the time from t2 to t3, the voltage Vₚ is maintained by the capacitance 107. In the period of one time frame T, such as during the period t1˜t3, the pixel voltage is Vₚ₁ and the display using the active matrix driver 100 is in the white mode. In the period of a next time frame, the pixel voltage may be another value such as Vₚ₂, for displaying different grays.

The LCD device using the active matrix driver 100 displays images through different voltages Vₚ applied to the pixel electrode 103. In other words, the gray level of the display is determined by the voltage Vₚ. Typically, each next time frame should be accompanied by a quick change in the voltage Vₚ, for providing good display performance when the display shows dynamic pictures. If Vₚ₂ is much more than Vₚ₁ or much less than Vₚ₁, then these two time frames can be displayed clearly. However, if Vₚ₂ is not much more than Vₚ₁ or not much less than Vₚ₁ at the next frame, the gray level is just a little higher or lower than before, and the difference between the two applied voltages is small. Because liquid crystals are “adhesive,” the liquid crystal layer needs more time to change from one station to the next station. The next gray picture may cover the last gray picture, making the display image blurred.

### SUMMARY OF THE INVENTION

An object of the present invention is to provide an active matrix driver for an LCD device which displays different grays through controlling the times that voltages are applied to the LCD device.

Another object of the present invention is to provide an active matrix driver which gives an LCD device good display performance when the display shows dynamic pictures.

In order to achieve the objects set forth, an active matrix driver adapted to controlling display image of an LCD device comprises a number of pixel electrode, a common electrode combined with the pixel electrode forming a number of capacitances, a number of scanning lines and signal lines intersecting with each other respectively; and a number of thin film transistors positioned vicinity corners of the scanning lines and signal lines, and electrically connected with the pixel electrodes, the scanning lines and the signal lines. A time period of the voltage applied on the pixel electrode is changeable according to the gray level needed by the display image, and so display different grays are obtained through controlling the time that the voltages is applied to the LCD device.

Other objects, advantages and novel features of the invention will become more apparent from the following detailed description when taken in conjunction with the accompanying drawings.

### BRIEF DESCRIPTION OF THE DRAWINGS

FIG. 1 is a circuit diagram of an active matrix driver of the present invention, the active matrix driver comprising a number of first and second TFTs and pixel electrodes.

FIG. 2 is an enlarged view of one pixel region of FIG. 1, which comprises one first TFT and one second TFT.

FIG. 3(a) is a graph showing a voltage waveform applied to a gate electrode of the first TFT of FIG. 2 in one time period.

FIG. 3(b) is a graph showing a voltage waveform applied to a source electrode of the first TFT of FIG. 2 in one same time period.

FIG. 4(a) is a graph showing a voltage waveform applied to a gate electrode of the second TFT of FIG. 2 in one time period.

FIG. 4(b) a graph showing a voltage waveform applied to a source electrode of the second TFT of FIG. 2 in one same time period.

FIG. 4(c) is a graph showing a voltage waveform of the first and the second TFTs applied to the pixel electrodes of FIG. 1 in one same time period.

FIG. 5 is a circuit diagram of a conventional active matrix driver, the active matrix comprising a number of TFTs and pixel electrodes.

FIG. 6 is an enlarged view of one pixel region of FIG. 5, which comprises one TFT.

FIG. 7(a) is a graph showing a voltage waveform applied to a gate electrode of the TFT of FIG. 6.

FIG. 7(b) a graph showing a voltage waveform applied to a source electrode of the TFT of FIG. 6.

FIG. 7(c) is a graph showing a voltage waveform of the TFTs applied to the pixel electrodes of FIG. 5.

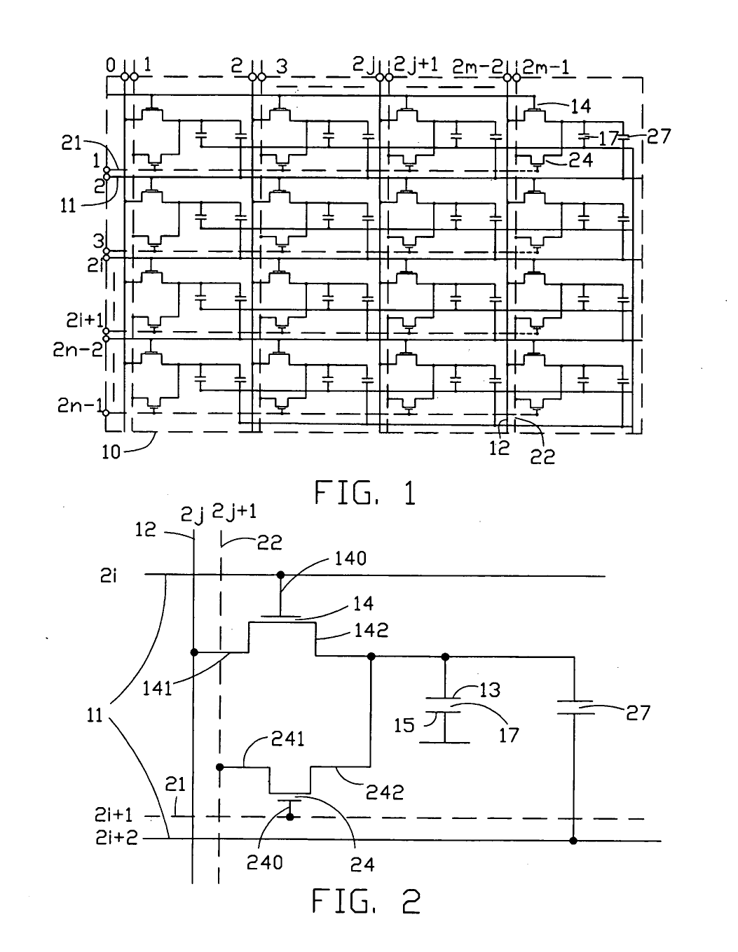

### DETAILED DESCRIPTION OF THE INVENTION

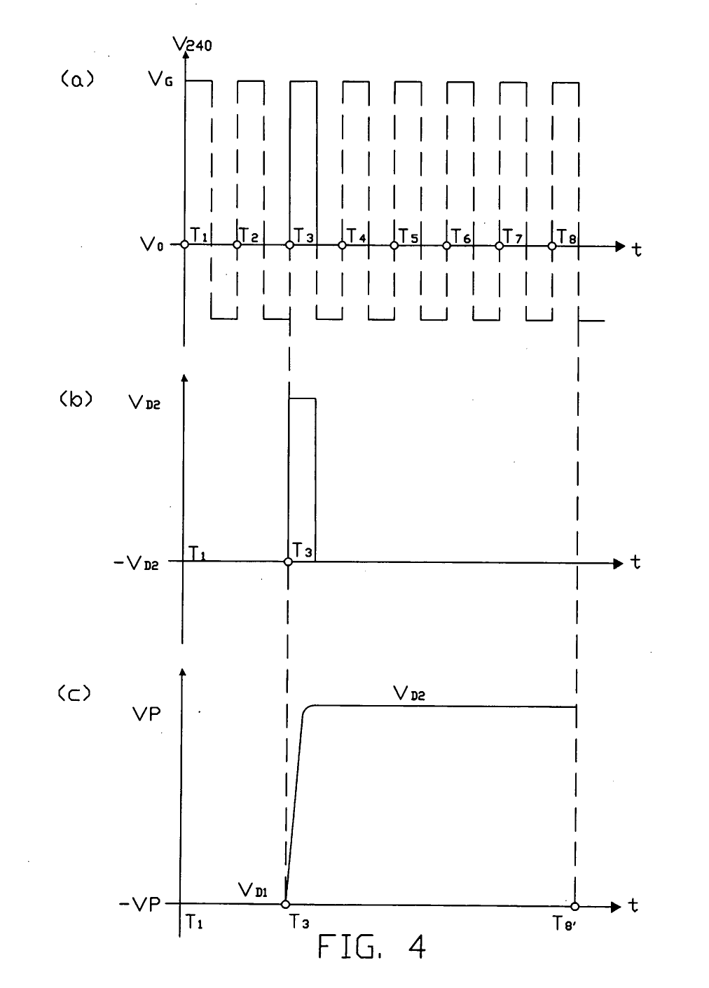

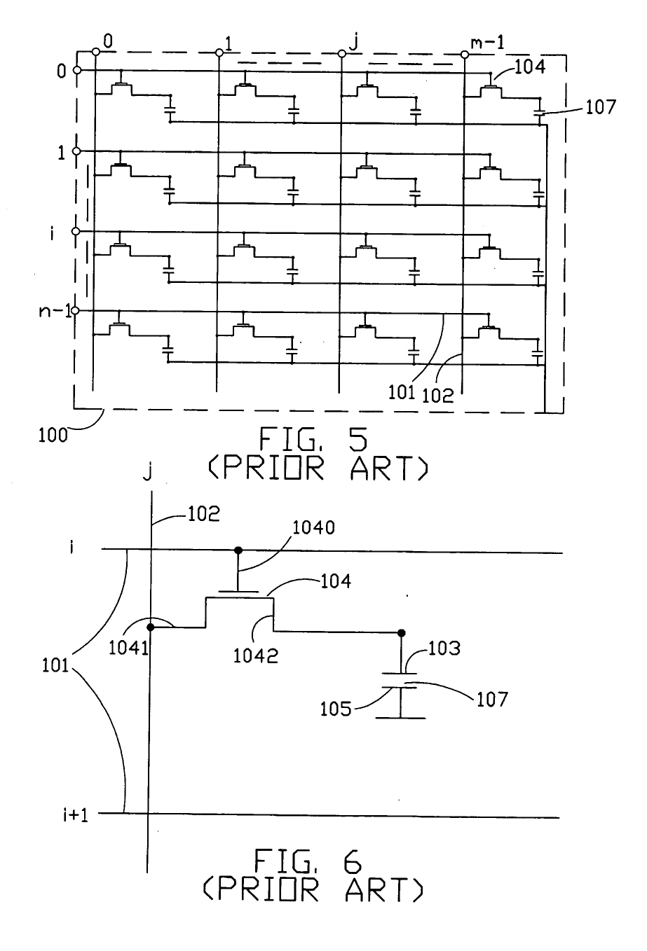

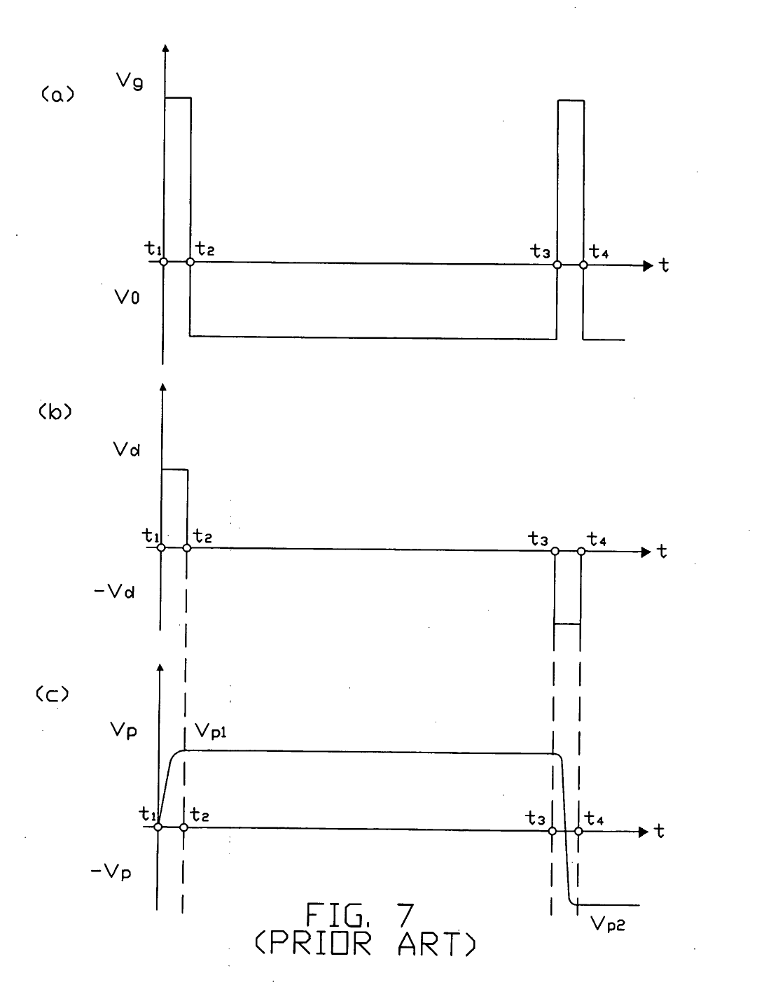

Referring to FIGS. 4 and 5, an active matrix driver 10 in accordance with a preferred embodiment of the present invention comprises a number of first scanning lines 11 (numbered from 1, 3 to 2n-1), a number of second scanning lines 21 (numbered from 0, 2 to 2(n-1)) positioned parallel to each other, a number of first signal lines 12 (numbered from 1, 3 to 2m-1), a number of second signal lines 22 (numbered from 0, 2 to 2(m-1)) positioned parallel to each other, pixel electrodes 13, common electrodes 15 respectively opposite to the pixel electrodes 13, and first TFTs (Thin Film Transistors) 14 and second TFTs 24 as the switching elements. The first and second scanning lines 11, 21 are perpendicular to the first and second signal lines 12, 22 respectively. The first and second TFTs 14, 24 are located in the vicinity of the intersections of the scanning lines 11, 21 and the signal lines 12, 22, for driving the pixel electrodes 13. The first scanning lines 11 are connected to first gate electrodes 140 of the first TFTs 14, the first signal lines 12 are connected to first source electrodes 141 of the first TFTs 14, the second scanning lines 21 are connected to second gate electrodes 240 of the second TFTs 24, the second signal lines 22 are connected to second source electrodes 241 of the second TFTs 24, and first and second drain electrodes 142, 242 of the first and second TFTs 14, 24 are both connected to the pixel electrodes 13. Each pixel electrode 13 combined with a corresponding common electrode 15 forms a capacitance 17, and each pixel electrode 13 combined with a next scanning electrode forms an accessory capacitance 27.

Unlike the conventional active matrix driver 100, the active matrix driver 10 of the present invention applies a high voltage to an LCD device, and display different grays through controlling the time that the voltage is applied to the LCD device. For the sake of simplicity, it will be assumed that the display has eight gray levels, that we need to display a third gray level, and that therefore the period T of one frame is separated into eight parts.

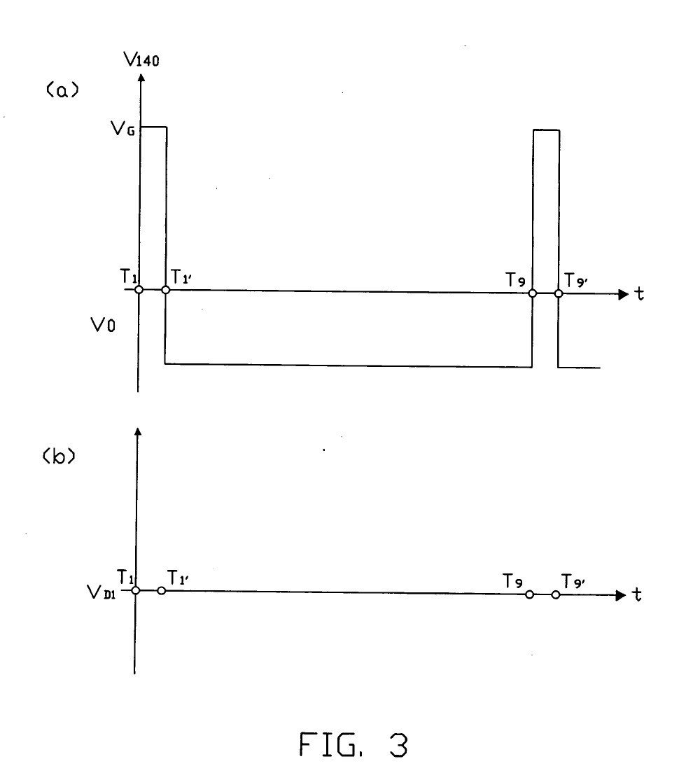

Referring to FIGS. 3 and 4, in operation, regarding just one pixel of the first and second TFTs 14 and 24, at the time t1, the first source electrode 141 of the first TFT 14 is supplied a normal signal voltage V_{D1}, and the first gate electrode 140 of the first TFT 14 is supplied a normal scanning pulse V_{G} in sequence. The first TFT 14 is open and the signal voltage V_{D1} is applied to the pixel electrode 13 via the first source electrode 141 and drain electrode 142 of the first TFT 14. Because a third gray level needs to be displayed, at the time t3, the second source electrode 241 of the second TFT 24 is supplied a very high signal voltage V_{D2}, for example between 4 Volts and 10 Volts. The second gate electrode 240 of the second TFT 24 is supplied a normal scanning pulse VG in sequence, and before time t3, the first TFT 14 is closed. The second TFT 24 is open and the very high signal voltage V_{D2} is applied to the pixel electrode 13 via the second source electrode 241 and drain electrode 242 of the second TFT 24. The first signal voltage V_{D1} make the liquid crystal layer prepare for change, and the second signal voltage V_{D2} make the liquid crystal layer change quickly. As shown in the FIG. 4(c), the pixel voltage follows the signal voltage V_{D1} and V_{D2}. In the time from t1 to t3, the pixel voltage increases to and is maintained at V_{D1}, and in the time from t3 to the remaining time of the one frame, the voltage V_{D2} is maintained by the capacitance 17. In the period of the next frame, for example, a fifth gray level may need to be displayed. First, the first TFT 14 is opened, and a normal voltage is applied to the pixel electrode 13. Then at the time t5, the second TFT 24 is opened, and a very high voltage is applied to the pixel electrode 13. In the remaining time of the frame, the high voltage is maintained by the capacitance 17. According to this procedure, different successive gray displays are attained.

Referring again to FIG. 4(c), in each gray level, the pixel electrode 13 is applied to two different level voltages, one is lower, such as V_{D1}, the other is higher, such as V_{D2}, and at different gray levels, the values of the two voltage is not changed, all maintain to a same level. So, if we change from one gray level to another gray level, the liquid crystal layer of the LCD device is applied to a high voltage, and it changes quickly according to a high voltage. More over, controlling the time of when apply voltage is more easy than controlling the change of the liquid crystal layer according to a very small change of voltage.

In fact, the first voltage V_{D1} applied to the pixel electrode 13 is just use to make the liquid crystal layer prepare for change quickly, so it also can be zero not influence our invention. In the example above, we also can at the beginning applied a high voltage to the pixel electrode 13, and at the time t6 switching the voltage when a third gray level need to be displayed.

It is to be understood that even though numerous characteristics and advantages of the present invention have been set forth in the foregoing description, together with details of the structure and function of the invention, the disclosure is illustrative only, and changes may be made in detail, especially in matters of method and arrangement of parts within the principles of the invention to the full extent indicated by the broad general meaning of the terms in which the appended claims are expressed.

1. An active matrix driver adapted to controlling display image of a liquid crystal display comprising:
a number of pixel electrode;
a common electrode combined with the pixel electrode forming a number of capacitances;
a number of scanning lines and signal lines intersecting with each other respectively; and
a number of thin film transistors positioned vicinity corners of the scanning lines and signal lines, and electrically connected with the pixel electrodes, the scanning lines and the signal lines;
wherein a time period of a voltage applied on the pixel electrodes is changeable according to the gray level needed by the image.

2. The active matrix driver as described in claim 1, wherein the voltage applied on the pixel electrodes has two different level during one period of one gray level, at the first time, the voltage is lower, at the remaining time according to the gray level, the voltage is higher.

3. The active matrix driver as described in claim 2, wherein the gray level is decided by the ratio of duration of the lower voltage and duration of the higher voltage.

4. The active matrix driver as described in claim 2, wherein the higher voltage is between 4 Volts and 10 Volts.

5. The active matrix driver as described in claim 1, further comprising a plurality of second scanning lines and second signal lines intersecting with each other respectively, and a number of second thin film transistors positioned vicinity corners of the second scanning lines and signal lines.

6. The active matrix driver as described in claim 5, wherein the second thin film transistors are electrically connected with the pixel electrodes, the second scanning lines and the second signal lines.

7. The active matrix driver as described in claim 6, wherein all the signal lines are extending in parallel, and all the scanning lines are extending in parallel in another direction which are orthogonal and insulated with each other.

8. The active matrix driver as described in claim 5, wherein an open time of a gate electrodes of the second thin film transistors delays or equals to the close time of a gate electrodes of first thin film transistors, and the second thin film transistors are used for inputting a high voltage.

9. The active matrix driver as described in claim 5, wherein the pixel electrode combined with a corresponding next scanning electrode forms an accessory capacitance.

10. An active matrix driver adapted to controlling display image of a liquid crystal display comprising:
a number of pixel electrode;
a common electrode combined with the pixel electrode having a number of capacitances;
a number of scanning lines and signal lines intersecting with each other respectively; and
a number of thin film transistors positioned vicinity areas of the scanning lines and signal lines, and electrically connected with the pixel electrodes, the scanning lines and the signal lines;
wherein a time period of a voltage applied on the pixel electrodes is changeable according to the gray level needed by the image.

11. An active matrix driver adapted to controlling display image of a liquid crystal display comprising:
a number of pixel electrode;
a common electrode combined with the pixel electrode forming a number of capacitances;
a number of scanning lines and signal lines intersecting with each other respectively; and
a number of thin film transistors positioned vicinity corners of the scanning lines and signal lines, and electrically connected with the pixel electrodes, the scanning lines and the signal lines;
wherein two transistors are directly involved with and connected to two pairs of signal and scanning lines.
